(19) United States
(12) Patent Application Publication
(10) Pub. No.: US 2004/0249828 A1
(43) Pub. Date: Dec. 9, 2004

(54) Automated infrastructure audit system

(75) Inventors: Rhonda L. Childress, Austin, TX (US); Brent Watson Lamm, Bailey, NC (US); Thomas Lane Newton, Cumming, GA (US); Michael Bruce Oliver, Nicholasville, KY (US); Ravirajan Rajan, Apex, NC (US); Jonathan Samn, Austin, TX (US); Steven M. Weinberger, Lewis Center, OH (US)

Correspondence Address: IBM CORP (YA), C/O YEE & ASSOCIATES PC, P.O. BOX 802333, DALLAS, TX, 75380, US

(73) Assignee: International Business Machines Corporation, Armonk, NY

(21) Appl. No.: 10/455,184

(22) Filed: Jun. 5, 2003

(51) Int. Cl. G06F 7/00

(52) U.S. Cl. 707/100

(57) ABSTRACT

The present invention provides an automated method and system for auditing infrastructures in a managed region of a resource management system. A resource management region queries the endpoints in the system, retrieves reference infrastructure configuration data, and stores the data in a database. At a later time, the resource management region again queries the endpoints and the resource management region itself, and retrieves current infrastructure configuration data. Changes in the state of the system infrastructure from the time the reference infrastructure data is generated to the time the current infrastructure data is generated is found by comparing the reference infrastructure data to the current infrastructure data. The resource management region transmits a notification to the system administrator if unauthorized changes are found. The present invention reduces the large amount of administrative and maintenance labor costs that can occur when settings in the infrastructure are inconsistent with what they are thought to be.

### BACKGROUND OF THE INVENTION

1. Technical Field

The present invention relates to an improved computing system. More particularly, the present invention relates to a method and apparatus for auditing infrastructures in a managed region of a resource management system.

2. Description of Related Art

In data processing systems, the term infrastructure can be viewed as everything that supports the flow and processing of information. This term includes interconnecting hardware and software, as well as computers and other devices that are interconnected. Monitoring the state of the infrastructure is of particular important to system administrators. It is essential that, at any given time, the state of infrastructure of a machine should be what it is expected to be.

A problem encountered with data processing systems is that the infrastructure of the system may change or be changed without administrator approval. Ideally, all changes to the system infrastructure should be managed such that the “should be” state of the infrastructure is updated appropriately. However, changes in the configuration can occur outside of the correct mechanisms. Such unapproved changes are undesirable because they create inconsistencies within the infrastructure. For example, if a Windows endpoint has a setting that specifies the path of a log file, and that setting is accidentally put in a UNIX format, then an error in finding that log file could show as the log file is missing even though the file is there. Another example would be that a setting that specifies that an endpoint should be scanned as a Windows machine rather an Advanced Interactive Executive (AIX) machine could cause many errors when the scan produces several errors. In large-scale complex systems, an unapproved change is particularly onerous, for the change may be one small setting out of a million infrastructure settings. Administrators traditionally faced a long and tedious process if they attempted to locate the change, for administrators had to check each setting one by one.

Thus, it would be beneficial to have a method and system for auditing the configuration of the infrastructure to verify that the state of the system is what it should be by comparing stored state data to later retrieved data to locate discrepancies in the configuration of the infrastructure. It would further be beneficial to have an automated method for auditing the configuration of the infrastructure.

### SUMMARY OF THE INVENTION

The present invention provides an automated method and system for auditing infrastructures in a managed region of a resource management system. With the apparatus and method of the present invention, a resource management region queries the endpoints, or clients, for infrastructure configuration information. The endpoints may gather the infrastructure configuration information from configuration files which may be located within an endpoint or on the resource management region. Infrastructure configuration information can be gathered, for example, from running commands from the command line interface by executing pre-existing commands, such as those developed by Tivoli, which return values. After the resource management region retrieves the infrastructure configuration information from the endpoints, the resource management region generates a reference file that details the state of the infrastructure of the data processing system. This reference file containing the state of the infrastructure is then stored in a database.

At a later time, discrepancies between the stored state of the infrastructure and the current state of the infrastructure may be located by comparing the stored reference file to a new file containing the current state of the infrastructure. Discrepancies can include authorized and unauthorized changes to the infrastructure configuration. The resource management region generates the current file in the same manner as the reference file was generated. However, since the current file is generated at a later time than the reference file, changes to the infrastructure configuration may have occurred from the time the reference file was generated. The resource management region uses a comparison engine to locate such changes by comparing the stored reference file to the current file.

If any discrepancies between the reference configuration file and the current configuration file are found, resource management region transmits a notification to a designated recipient. For example, designated recipient may be a system administrator. The notification sent to designated recipient informs the recipient that the state of the infrastructure needs to be changed if the change was authorized in the system environment, but not yet fixed in the stored reference file in the database. The notification may include such contents as a list of the discrepancies between the gathered data and the stored data, report dates, customer IDs, endpoint names, and the like.

The present invention reduces the large amount of administrative and maintenance labor costs that can occur when settings in the infrastructure are inconsistent with what they are thought to be. Unauthorized changes to the infrastructure configuration may be caught and remedied before they are propagated and cause additional problems.

The above as well as additional objectives, features, and advantages of the present invention will become apparent in the following detailed written description.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 depicts a pictorial representation of a distributed data processing system in which the present invention may be implemented;

FIG. 2 is a block diagram illustrating a data processing system in which the present invention may be implemented;

FIG. 3 is a diagram that depicts the elements that may be used in a data processing system implementing the present invention;

FIG. 4 is flowchart depicting a process in the logical design in accordance with the present invention; and

FIG. 5 is a diagram depicting the elements that may be used in a managed multiple audit system implementing the present invention.

### DETAILED DESCRIPTION OF THE PREFERRED EMBODIMENT

The present invention provides an automated method and apparatus for auditing infrastructures in a managed region of a resource management system. The present invention may be implemented in any distributed computing system. In a preferred embodiment, the present invention is implemented in a Tivoli Management Region comprised of a TMR region, or resource management region, and one or more managed nodes in which a Tivoli framework is utilized upon which Tivoli applications are run.

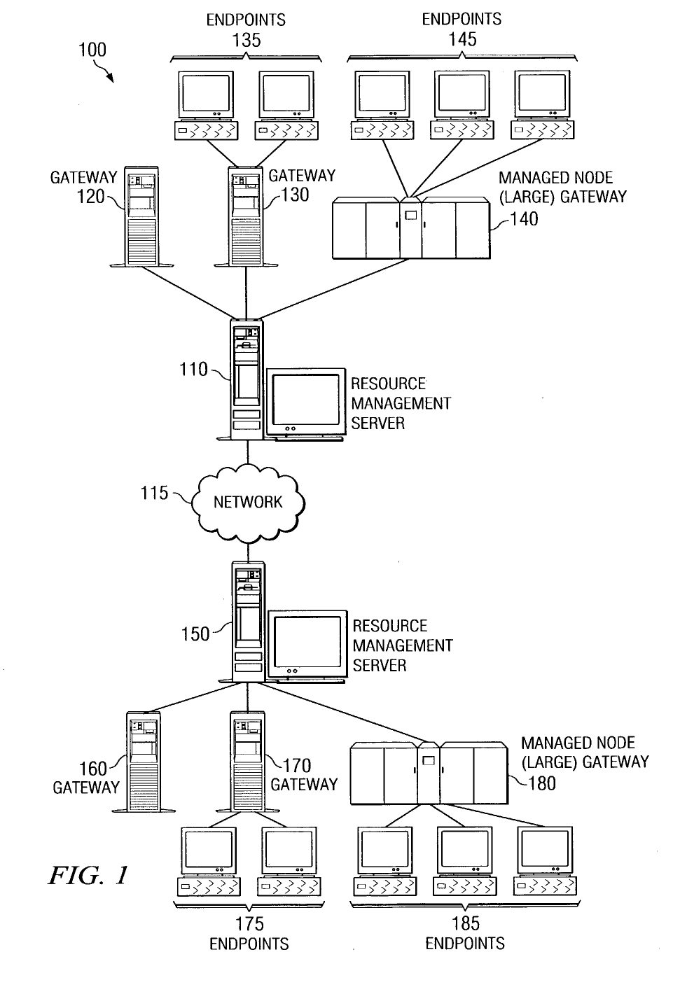

FIG. 1 is an exemplary diagram of a distributed computing system 100 in accordance with the present invention. As shown in FIG. 1, the distributed computing system includes a first resource management server 110 coupled to another resource management server 150 via a network 115, which is the medium used to provide communications links between various devices and computers connected together within the distributed computing system 100. Network 115 may include connections, such as wire, wireless communication links, fiber optic cables, and the like.

In the depicted example, the resource management servers 110 and 150 manage resources on gateways 120-130, 160-170 and managed nodes 140 and 180. Clients, or endpoints, 135, 145, 175 and 185 operate via the gateways or managed nodes, respectively. The distributed computing system 100 may include additional servers, clients, and other devices not shown. The endpoints may be personal computers, workstations, printers, scanners, storage devices, or any other device capable of communication with the gateways or managed nodes.

In the depicted example, the network 115 may be the Internet with network 115 representing a worldwide collection of networks and gateways that use the TCP/IP suite of protocols to communicate with one another. At the heart of the Internet is a backbone of high-speed data communication lines between major nodes or host computers, consisting of thousands of commercial, government, educational and other computer systems that route data and messages.

Of course, distributed computing system 100 also may be implemented as a number of different types of networks, such as for example, an intranet, a local area network (LAN), a wide area network (WAN), or the like. FIG. 1 is intended as an example, and not as an architectural limitation for the present invention.

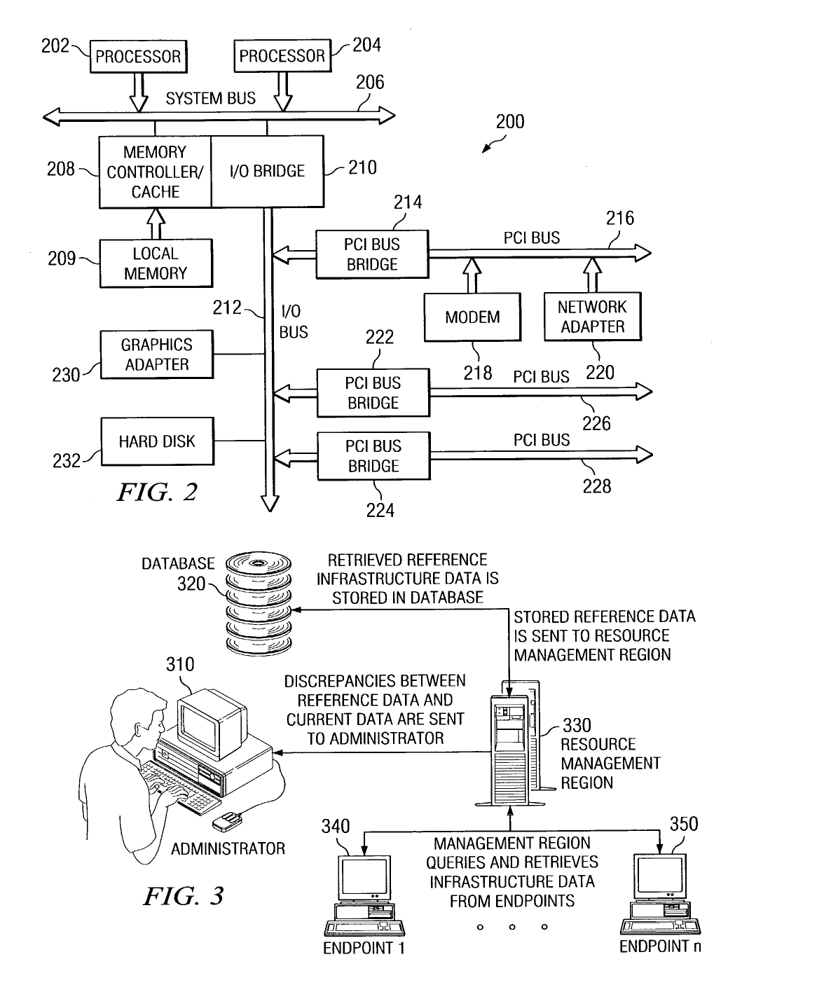

Referring to FIG. 2, a block diagram of a data processing system that may be implemented as a server, such as server 110 or 150 in FIG. 1, is depicted in accordance with a preferred embodiment of the present invention. Data processing system 200 may be a symmetric multiprocessor (SMP) system including a plurality of processors 202 and 204 connected to system bus 206. Alternatively, a single processor system may be employed. Also connected to system bus 206 is memory controller/cache 208, which provides an interface to local memory 209. I/O bus bridge 210 is connected to system bus 206 and provides an interface to I/O bus 212. Memory controller/cache 208 and I/O bus bridge 210 may be integrated as depicted.

Peripheral component interconnect (PCI) bus bridge 214 connected to I/O bus 212 provides an interface to PCI local bus 216. A number of modems may be connected to PCI local bus 216. Typical PCI bus implementations will support four PCI expansion slots or add-in connectors. Communications links to managed nodes and gateways in FIG. 1 may be provided through network adapter 220 connected to PCI local bus 216 through add-in boards. Additional PCI bus bridges 222 and 224 provide interfaces for additional PCI local buses 226 and 228, from which additional network adapters may be supported. In this manner, data processing system 200 allows connections to multiple network computers and devices. A memory-mapped graphics adapter 230 and hard disk 232 may also be connected to I/O bus 212 as depicted, either directly or indirectly.

Those of ordinary skill in the art will appreciate that the hardware in FIG. 2 may vary depending on the implementation. For example, other peripheral devices, such as optical disk drives and the like, may be used in addition to or in place of the hardware depicted. The depicted example is not meant to imply architectural limitations with respect to the present invention. For example, the processes of the present invention may be applied to multiprocessor data processing systems.

The data processing system depicted in FIG. 2 may be, for example, an IBM eServer pSeries system, a product of International Business Machines Corporation in Armonk, N.Y., running the Advanced Interactive Executive(AIX) operating system or LINUX operating system. As discussed previously, the present invention provides a mechanism for auditing infrastructures in managed regions. With the present invention, four basic functions are performed: generating a reference infrastructure configuration file and a current infrastructure configuration file; comparing the reference infrastructure configuration file and current infrastructure configuration file to determining if there are discrepancies between the files; transmitting a notification to the system administrator if changes are found; and updating the reference configuration file in the database if changes to the infrastructure were authorized.

In the following examples, the auditing system will be described with regard to only one resource management server for the purpose of clarity. However, the principles and processes of the present invention may be utilized with two or more resource management servers without departing from the spirit and scope of the present invention.

Referring to FIG. 3, a block diagram illustrating an infrastructure audit system in accordance with the present invention. A resource management region 330 queries the endpoints, or clients, 340 and 350, for the state of the infrastructure. Endpoints 340 and 350 may gather the infrastructure configuration information from configuration files which may be located within an endpoint or on the resource management region. Infrastructure configuration information can be gathered, for example, from running commands from the command line interface by executing pre-existing commands, such as those developed by Tivoli, which return values. Resource management region 330 retrieves the infrastructure configuration information from the endpoints, and then generates a reference configuration file that contains details regarding the state of the management system's infrastructure. This reference configuration file containing the state of the infrastructure is then stored in a database 320.

At a later time, discrepancies between the stored state of the infrastructure and the current state of the infrastructure may be located by comparing the stored reference configuration file to a new file containing the current state of the infrastructure. Discrepancies can include authorized and unauthorized changes to the infrastructure configuration. Resource management region 330 may generate the current configuration file in the same manner as the reference configuration file was generated. However, since the current configuration file is generated at a later time than the reference configuration file, changes to the infrastructure configuration may have occurred from the time the reference configuration file was generated. Resource management region 330 uses a comparison engine to locate such changes by comparing the reference configuration file to the current configuration file.

If discrepancies between the reference configuration file and the current configuration file are found, resource management region 330 transmits a notification to a designated recipient 310. For example, designated recipient 310 may be a system administrator. The notification sent to designated recipient 310 may include such contents as a list of the discrepancies between the gathered data and the stored data, report dates, customer IDs, endpoint names, and the like.

Providing notification regarding discrepancies in the reference configuration file in database 320 updated if the discrepancies between the reference configuration file and the current configuration file are determined to have been authorized changes.

Thus, the present invention provides a mechanism for auditing infrastructures in a resource management distributed computing system. With the present invention, discrepancies between the state of the infrastructure contained in the earlier generated reference configuration file and the current state of the infrastructure contained in the current configuration file may be identified in order to locate unauthorized changes to the infrastructure.

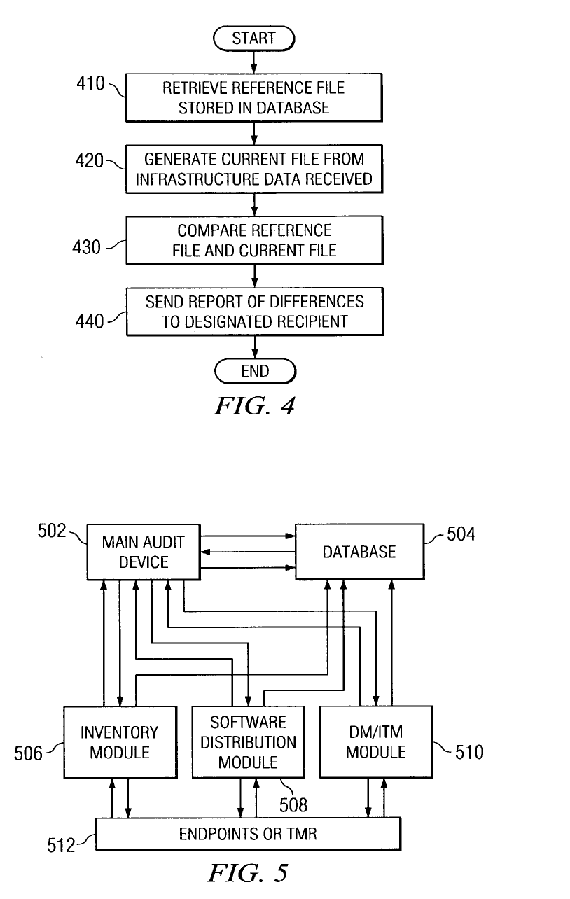

FIG. 4 is a flowchart outlining an exemplary operation of the present invention. It will be understood that each block of the flowchart illustrations, and combinations of blocks in the flowchart illustrations, can be implemented by computer program instructions. These computer program instructions may be provided to a processor or other programmable data processing apparatus to produce a machine, such that the instructions which execute on the processor or other programmable data processing apparatus create means for implementing the functions specified in the flowchart block or blocks. These computer program instructions may also be stored in a computer-readable memory or storage medium that can direct a processor or other programmable data processing apparatus to function in a particular manner, such that the instructions stored in the computer-readable memory or storage medium produce an article of manufacture including instruction means which implement the functions specified in the flowchart block or blocks.

Accordingly, blocks of the flowchart illustrations support combinations of means for performing the specified functions, combinations of steps for performing the specified functions and program instruction means for performing the specified functions. It will also be understood that each block of the flowchart illustrations, and combinations of blocks in the flowchart illustrations, can be implemented by special purpose hardware-based computer systems which perform the specified functions or steps, or by combinations of special purpose hardware and computer instructions.

As shown in FIG. 4, the audit operation starts with retrieving a reference infrastructure configuration file for the resource management system from the database (step 410). Thereafter, a current infrastructure configuration file is generated by the resource management region from current infrastructure data received from the endpoints or gathered from the resource management region itself (step 420). A comparison is performed between the reference infrastructure configuration file and the current infrastructure configuration file (step 430). Discrepancies between the reference infrastructure configuration file and the current infrastructure configuration file are then identified and transmitted to a designated recipient (step 440).

As mentioned previously, the present invention involves generating reference and current configuration files and identifying differences between these files. The present invention may also be implemented in individual modules, each operating simultaneously within a main program. FIG. 5 illustrates how the invention is expandable and shows the process flow for a main audit device having sub-components, or modules. FIG. 5 shows how different modules, in this example the different modules include an inventory module 506, a software distribution module 508, and a distributed monitoring (DM)/ITM module 510, may be included in the system. Each module performs an audit of a particular segment of the infrastructure. Main audit device 502 manages the entire audit process. Main audit device 502 requests the different modules gather and collect data regarding the system infrastructure. Main audit device 502 can run an audit on the entire system, thereby receiving infrastructure data from all of the modules, or it can run an audit on an individual module. Multiple simultaneous queries can also be achieved by allowing multiple instances of main audit device 502, from the same server or multiple servers.

Using inventory module 506 as an example, if main audit device 502 runs an audit to determine that all inventory structures are in the correct working order, inventory module 506 will query the endpoints and/or resource management system 512 for current inventory infrastructure data. Endpoints and/or resource management system 512 return the data to inventory module 506. Inventory module 506 then requests stored inventory infrastructure data from configuration management database 504. The modules compare the desired structure stored in the database with the current data. If the comparison results in any discrepancies, inventory module 506 reports the discrepancies to main audit device 502. Inventory module 506 also returns the formatted data to main audit device 502, which stores the data in database 504.

The present invention as illustrated in FIG. 5 shows three audit modules—inventory, software distribution, and DM/ITM. However, the present invention is not limited to particular modules, nor is it specific to a certain product. This means that the uses for the present invention are only limited by the number of other products that a user may want to audit. To facilitate this process, new database tables and queries should be created, and modules for each product may only need to be added to the invention's directory source path. When a new product is added to the environment, a new module can be built for the new product so that the new module is available to the main audit device to run an audit on that segment of the infrastructure. Each module will perform the comparison of the reference configuration file and the current configuration file and transmit discrepancies to the designated recipient of the present invention.

Thus, the present invention provides an apparatus and method for auditing infrastructures in a resource management system. The advantages of the present invention should be apparent in view of the detailed description provided above. One can eventually locate a problem within the infrastructure of a data processing system using existing methods. However, such a task has proven to be difficult and time-consuming since each individual setting within the infrastructure must be checked until the problem is found. In contrast, the present invention not only reduces the extreme amount of time and resources used to check the consistency of an infrastructure via a nearly automated task, but it will help ensure that an infrastructure will be configured as it should be, reducing problems caused by the infrastructure inconsistencies.

It is important to note that while the present invention has been described in the context of a fully functioning data processing system, those of ordinary skill in the art will appreciate that the processes of the present invention are capable of being distributed in the form of a computer readable medium of instructions and a variety of forms and that the present invention applies equally regardless of the particular type of signal bearing media actually used to carry out the distribution. Examples of computer readable media include recordable-type media such a floppy disc, a hard disk drive, a RAM, and CD-ROMs and transmission-type media such as digital and analog communications links.

The description of the present invention has been presented for purposes of illustration and description, but is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. A method of auditing an infrastructure in a data processing system, the method comprising:
identifying a reference infrastructure state in a resource management system;
identifying a current infrastructure state in the resource management system;
determining differences between the reference infrastructure state and the current infrastructure state; and
transmitting a notification to a designated recipient if differences between the reference infrastructure state and the current infrastructure state are identified.

2. The method of claim 1, further comprising:
storing the reference infrastructure state in a database.

3. The method of claim 1, further comprising:
manually updating the reference infrastructure state in the database with the current infrastructure state.

4. The method of claim 1 wherein the resource management system is a Tivoli Management Region (TMR).

5. The method of claim 1 wherein the notification is sent to a system administrator.

6. The method of claim 1 wherein the notification includes a report date.

7. The method of claim 1 wherein the notification includes at least one customer ID.

8. The method of claim 1 wherein the notification includes at least one endpoint name.

9. The method of claim 1 wherein identifying a current infrastructure state in the resource management system includes gathering infrastructure data from the resource management system itself.

10. The method of claim 1 wherein identifying a current infrastructure state in the resource management system includes gathering infrastructure data from an endpoint connected to the resource management system.

11. The method of claim 1 wherein identifying a current infrastructure state in the resource management system is performed using CLI commands.

12. A data processing system for auditing an infrastructure, comprising:
means for identifying a reference infrastructure state in a resource management system;
means for identifying a current infrastructure state in the resource management system;
means for determining differences between the reference infrastructure state and the current infrastructure state; and
means for transmitting a notification to a designated recipient if differences between the reference infrastructure state and the current infrastructure state are identified.

13. The data processing system of claim 12, further comprising:
means for storing the reference infrastructure state in a database.

14. The data processing system of claim 12, further comprising:
means for updating the reference infrastructure state in the database with the current infrastructure state.

15. The data processing system of claim 12 wherein the resource management system is a Tivoli Management Region (TMR).

16. The data processing system of claim 12 wherein the notification includes a report date.

17. The data processing system of claim 12 wherein the notification includes at least one customer ID.

18. The data processing system of claim 12 wherein the notification includes at least one endpoint name.

19. The data processing system of claim 12 wherein identifying a current infrastructure state in the resource management system includes gathering infrastructure data from the resource management system itself.

20. The data processing system of claim 12 wherein identifying a current infrastructure state in the resource management system includes gathering infrastructure data from at least one endpoint connected to the resource management system.

21. A data processing system for performing a infrastructure audit, comprising:
a data extraction program for gathering a reference infrastructure state;
a data extraction program for gathering a current infrastructure state;
a comparison engine for comparing the reference infrastructure state to the current infrastructure state;
a notification engine for reporting any discrepancies between the reference infrastructure state and the current infrastructure state.

22. The data processing system of claim 21, further comprising:
a database for storing the reference infrastructure state.

23. A computer program product in a computer readable medium for auditing an infrastructure, comprising:
instructions for identifying a reference infrastructure state in a resource management system;
instructions for identifying a current infrastructure state in the resource management system;
instructions for determining differences between the reference infrastructure state and the current infrastructure state; and
instructions for transmitting a notification to a designated recipient if differences between the reference infrastructure state and the current infrastructure state are identified.

24. The computer program product in claim 23, further comprising:
instructions for storing the reference infrastructure state in a database.

25. A system for auditing an infrastructure, the system comprising:
a database;
a plurality of audit modules, wherein each of the plurality of audit modules identifies changes that occur to the infrastructure over time and audits a different segment of the system infrastructure; and
a main audit device, wherein the main audit device requests at least one of the plurality of audit modules to identify changes that occur to the infrastructure over time, gathers audit data, and stores the audit data in the database.
